(19) United States
(12) Patent Application Publication
(10) Pub. No.: US 2010/0145814 A1
(43) Pub. Date: Jun. 10, 2010

(54) ACCESS MODELING IN A COMMUNICATION DOMAIN

(75) Inventors: DEVEN MEGHANI, CLIFTON, NJ (US); PRADEEP KHOWASH, MARLBORO, NJ (US)

Correspondence Address: AT&T Legal Department - T&W;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 12/329,862

(22) Filed: Dec. 8, 2008

(51) Int. Cl. G06Q 10/00; G06Q 50/00; G06Q 30/00; G01C 21/00

(52) U.S. Cl. 705/26; 705/400; 701/300; 705/34

(57) ABSTRACT

System(s) and method(s) that facilitate efficient and automated processing of orders for access services are presented. An address validation engine evaluates received information that identifies at least part of a geographical location of a consumer ordering an access service, and accesses additional information to facilitate determining and validating the geographical location to a fine level of granularity. An access management component can facilitate automatically determining an available access provider(s) based on the validated geographical location. The access management component employs a rule engine to facilitate automatically and dynamically determining cost of the access service and selecting an access provider based on predefined rules in accordance with predefined access criteria. Electronic bonding is employed to facilitate automatic communication of information between the access provider and an entity processing the order to facilitate processing the order, provisioning the access service, and billing the consumer.

### TECHNICAL FIELD

The subject innovation generally relates to access in a communication domain, and, more particularly, to modeling an access architecture and applying it in the communication domain.

### BACKGROUND

Conventionally, communication access ordering architecture does not support data checks with regard customer addresses, service availability, choice of carriers, and specific costs of access of respective carriers. For instance, typically, customer addresses are not validated at all or are not validated down to a fine granular level, or are validated manually. The cost of an access service can be dependent in part on the geographic location where the consumer desires the access service. Thus, it is desirable to obtain accurate and detailed geographic location information of consumers. Further, often respective pricing or changes in pricing for access services provided by respective access providers is not accurately maintained or updated, which can lead to a sales person making an offer to a potential consumer that is based on an inaccurate price, which potentially can result in lost income by the entity offering the access to the consumer if the cost incurred by the entity in purchasing the access service from the access provider to re-sell it to the consumer is higher than the sales person believed it to be, or potentially can result in a lost sale if the sales person mistakenly believes the cost incurred by the entity for the access service is higher than believed by the sales person, who may then offer to sell the access service to the consumer at a higher price that is desirable. It is desirable to maintain accurate cost information with regard to access services provided by access providers

Also, the availability of services provided by access providers may change over time, where, for instance, access providers may broaden the geographic areas in which they offer certain services and/or may add new services. It can be desirable to maintain accurate information regarding the access services offered in respective geographic regions by access providers. Moreover, conventional access ordering models are manually intensive, which can result in undesirably long periods of time to process orders and can result in an undesirable amount of errors in processing orders. It is also desirable to automate the access ordering process and to obtain desired data (e.g., accurate and detailed data) related to access orders on the front end of the order process to facilitate reducing errors in order processing, reducing delays in order processing, and increasing revenue.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject innovation provides system(s) and method(s) to facilitate efficient and automated processing of orders for access services (e.g., Digital Subscriber Line (DSL), Digital Signal-0 (DS0), Digital Signal-1 (DS1) or T-1, Digital Signal-3 (DS3) or T-3, Synchronous Transport Module-1 (STM1), etc.) to consumers in a communication domain (e.g., mobility domain). In an aspect, the subject innovation can comprise an address validation engine that can evaluate a received subset of information (e.g., information received from a consumer desiring an access service or a sales person assisting the consumer), comprising geographical location information, which can identify at least part of a geographical location of a consumer ordering an access service, and can access additional information from an address data store to facilitate determining and validating the geographical location of the consumer to a fine level of granularity (e.g., sub-address level of granularity, where the geographic location can be validated to a specific room number, floor number, and/or building number or identifier, as applicable). In one aspect, the address validation engine can present a user(s) (e.g., consumer, sales person) with one or more geographic locations, where one of the locations potentially can be validated as the desired geographic location. The address validation engine can generate and provide respective confidence levels to each of the presented geographic locations, or portions thereof, to facilitate validating a geographic location associated with the consumer.

In another aspect, an access management component can facilitate automatically determining an available access provider(s) based at least in part on the validated geographical location. The access management component can employ a rule engine that can employ one or more predefined rules, created in accordance with predefined access criteria (e.g., cost of an access service, performance by an access provider, time frame to provide an access service to the validated geographic location, etc.), to facilitate automatically and dynamically determining cost of the access service and selecting an access provider based at least in part on the predefined rules. For example, in accordance with desired predefined rules, the access management component can automatically and dynamically select an access provider that provides the access service at the lowest cost while also meeting at least minimum standards for other predefined access criteria. In another aspect, the subject innovation can employ electronic bonding (e-bonding) to facilitate automated communication of information between the selected access provider and the entity (e.g., re-seller) processing the order to facilitate processing the order, provisioning the access service, and/or billing the consumer for the access service.

In yet another aspect, methods that can facilitate efficient and automated processing of orders for access services are presented. In still another aspect, artificial intelligence can be employed to facilitate inferring or determining a parameter value and/or inferring or determining whether a function is to be performed (e.g., automatically performed).

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF DRAWINGS

FIG. 1 illustrates a block diagram of a system that can facilitate efficient ordering and provision of access services in accordance with various aspects of the disclosed subject matter.

FIG. 2 depicts a block diagram of a system that can facilitate efficient ordering and provision of access services in accordance with an aspect of the disclosed subject matter.

FIG. 3 illustrates a block diagram of a system that can facilitate processing of orders for access services in accordance with an aspect of the disclosed subject matter.

FIG. 4 depicted is a block diagram of a system that can employ intelligence to facilitate processing orders for access services in accordance with an embodiment of the disclosed subject matter.

FIG. 5 illustrates a flowchart of an example methodology for efficiently processing orders for access services in accordance with an aspect of the disclosed subject matter.

FIG. 6 illustrates a flowchart of an example methodology that can facilitate processing orders for access services in accordance with an aspect of the disclosed subject matter.

FIG. 7 illustrates a flowchart of an example methodology that can validate a geographical location of a consumer to facilitate processing orders for access services in accordance with an aspect of the disclosed subject matter.

FIG. 8 depicts a flowchart of an example methodology that can automatically and dynamically determine cost of an access service and select an access provider to facilitate efficient processing of an order for an access service in accordance with an aspect of the disclosed subject matter.

FIG. 9 depicts a flowchart of an example methodology that can manage pending requests for access services to facilitate efficient order management related to access services in accordance with an aspect of the disclosed subject matter.

FIG. 10 is a schematic block diagram illustrating a suitable operating environment.

FIG. 11 is a schematic block diagram of a sample-computing environment.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” “subscriber station,” “communication device,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B (HNB),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” “consumer,” “prosumer,” “agent,” and the like are employed interchangeably throughout the subject specification, unless context warrants particular distinction(s) among the terms. As utilized herein, the term “prosumer” indicate the following contractions: professional-consumer and producer-consumer.

Conventionally, the ordering architecture with regard to access services does not support data checks as it relates to customer addresses, access service availability, choice of carriers (e.g., access providers), and respective costs of the carriers. As a result, undesirable and unnecessary errors can occur during order processing, which can result in order processing delays, lost revenue, and unsatisfactory service.

Systems and methods that facilitate efficient order processing with regard to access services in a communication domain(s) (e.g., mobility domain) are presented. The subject innovation presents an end-to-end architecture model that can define various objects as they relate to access. The new objects can account for or relate to new automated functions, which were not conventionally defined or were being handled manually. The new objects can be invoked on an “on demand” basis. Further, data associated with all order processes can be stored in a logical database in a centralized repository. Interactions between different applications can be achieved via a web service interface.

In accordance with an aspect, the subject innovation can comprise an address validation engine that can evaluate a received subset of information, comprising geographical location information, which can identify at least part of a geographical location of a consumer ordering an access service, and can access additional information to facilitate determining and validating the geographical location of the consumer to a fine level of granularity (e.g., sub-address level of granularity, where the geographic location can be validated to a specific room number, floor number, and/or building number or identifier, as applicable). An access management component can facilitate automatically determining an available access provider(s) based at least in part on the validated geographical location. The access management component can employ a rule engine to facilitate automatically and dynamically determining cost of the access service and selecting an access provider based at least in part on predefined rules in accordance with predefined access criteria (e.g., selecting an access provider that provides the access service at the lowest cost while also meeting at least minimum standards for other predefined access criteria; or selecting an access provider that has a highest rating). Electronic bonding (e-bonding) can be employed to facilitate automatic communication of information between the access provider and the entity processing the order to facilitate processing the order, provisioning the access service, and/or billing the consumer.

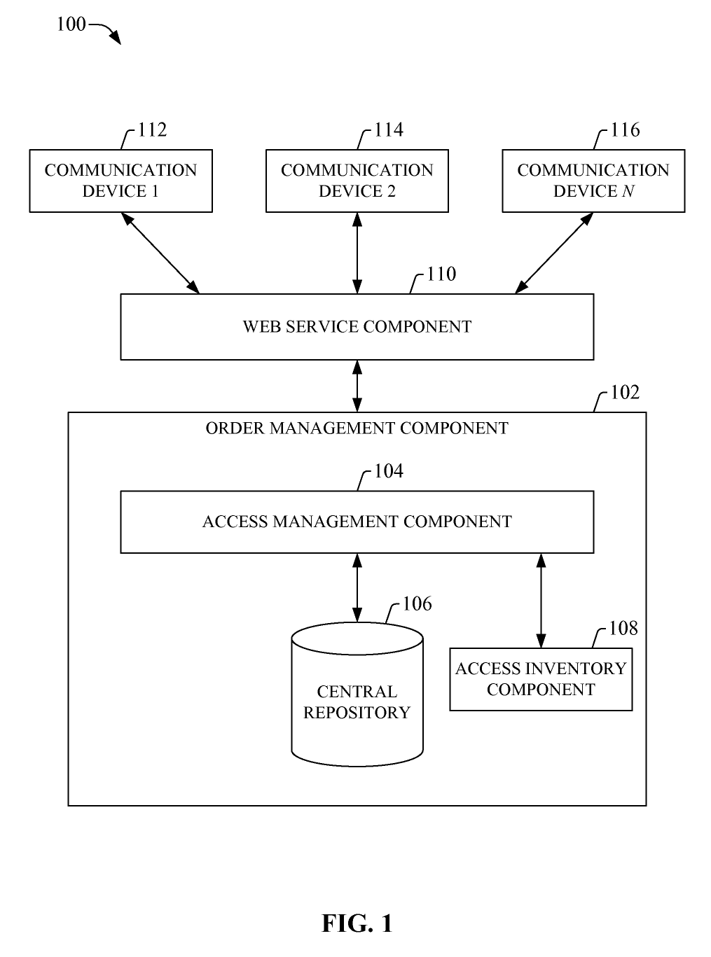

Turning to FIG. 1, illustrated is a block diagram of a system 100 that can facilitate efficient ordering and provision of access services in accordance with various aspects of the disclosed subject matter. In an aspect, the system 100 can comprise an order management component 102 that can facilitate efficient and automated processing of orders for access services (e.g., wireless communication access, wired communication access) from access providers. The order management component 102 can include an access management component 104 that can facilitate performing various functions, such as address validation, service management, cost management, provisioning of access services, billing for access services, associated with processing orders for access services. The access services that can be ordered via the order management component 102 can comprise, for example, Digital Subscriber Line (DSL), Digital Signal-0 (DS0), Digital Signal-1 (DS1) or T-1, Digital Signal-3 (DS3) or T-3, Synchronous Transport Module-1 (STM1), E0, E1, E2, E3, E4 and/or other access services, where the access service desired can depend in part on the size of the consumer and/or information need of the consumer (e.g., DSL may be desirable for a small business owner). Also, other or alternate technologies, such as Wi-Fi or fixed wireless, for example, can be ordered where the other technologies, such as DSL or DS1, are not available.

In an aspect, the access management component 104 can be associated with (e.g., connected to) a central repository 106 that can be a centralized storage component utilized for storing data related to processing orders for access services, where the data can relate to information associated with consumers or potential consumers, information that can facilitate validating an address of a consumer, information that can facilitate determining what access service(s) is available for a particular consumer at a particular geographic location, information that can facilitate selecting a desired access service and access provider for a consumer, etc. The access management component 104 also can be associated with an access inventory component 108 that can facilitate identifying the access service inventory and providing desired access services to consumers.

In accordance with an aspect, the order management component 102 can be associated with a web service component 110 that can be employed to facilitate communication with one or more communication devices, such as communication device 1 (112), communication device 2 (114), and through communication device N 116 (e.g., N communication devices, where N can be virtually any desired integer number) associated with sales persons, who can be associated with an entity, associated with the order management component 102, that sells (e.g., re-sell) access services of access providers to consumers, and/or consumers that desire to request or inquire about services that can be provided via the order management component 102. The web service component 110 can comprise an interface(s) and other communication functions that can be utilized to transfer information between the communication devices (e.g., 112, 114, and/or 116) and the order management component 102. The communication devices can employ and/or can access one or more applications that can facilitate generating and processing orders for access services, monitoring the status of orders, generating billing related to the orders for access services, and/or allowing payment for orders for access services.

In accordance with another aspect, the access management component 104 can receive a subset of information, which can comprise information that can identify at least a part of geographic location, associated with a consumer, who desires to request access services, via the web service component 110. In an aspect, the subset of information can comprise information that identifies the consumer and/or at least partially identifies the geographic location at which the consumer desires an access service. For example, the geographic location information can be at least part of an address (e.g., address number, street name, city, state, and/or zip code, . . . ) associated with the consumer. If the consumer is an existing customer, the access management component 104 can automatically retrieve information associated with the consumer from a central repository 106 in addition to receiving the subset of information.

The access management component 104 can analyze the received subset of information (e.g., partial geographic location, business name, and/or phone number, associated with the consumer) to facilitate determining and validating (e.g., automatically validating) in real time a desired (e.g., complete) geographic location associated with the consumer to a desired level of granularity (e.g., room number, floor number, building identifier or building number, street address, city, state, zip code, etc.), and based at least in part on the received subset of information, the access management component 104 can access the central repository 106 to retrieve additional geographic location information that is, or at least potentially is, associated with the consumer. The access management component 104 can automatically present one or more geographic locations that potentially can be a desired geographic location, having desired level of granularity, associated with the consumer, (e.g., the geographic location information of the subset and/or the additional geographic location information) to the sales person and/or consumer via the communication device (e.g., 112) to facilitate determining whether there is a validated geographic location (e.g., address) for the consumer. In an aspect, the presented geographic location(s) information can have all or a portion of the information highlighted, emphasized, or flagged based at least in part on a respective confidence level(s) with regard to respective pieces of the geographic location information, where the confidence level(s) can be determined by the access management component 104. For example, one or more colors (e.g., red, yellow, green) can be employed to highlight or flag a piece(s) of presented geographic location information to indicate a confidence level(s) in that piece(s) of information. This can facilitate accuracy in the geographic location associated with the consumer, as, for instance, information with a lower confidence level can be highlighted to the sales person or consumer so the information can be confirmed or replaced with valid information, as desired. If the desired geographic location, with the desired level of granularity (e.g., specified to a room and/or floor level, where applicable) is included in the information presented to the sales person and/or consumer, the desired geographic location can be selected, and the access management component 104 can determine that a geographic location associated with the consumer is validated. The validated geographic location can be stored to facilitate accurate determination of available access services, available access providers, and costs for an access service(s), which can facilitate reducing errors in pricing for access services and undesired delay in processing the order and providing the desired access service(s) to the consumer.

If the presented geographic location(s) is not a geographic location that can be validated to a desired level of granularity, the access management component 104 can transmit a prompt to the sales person and/or user via the communication device (e.g., 112) to have the sales person and/or user provide additional information to facilitate obtaining a valid geographic location to a desired fine level of granularity (e.g., sub-address level) for the consumer. If the geographic location cannot be validated for any reason (e.g., incorrect or insufficient information from the consumer), the access management component 104 can transmit a prompt to the sales person and/or consumer to have the sales person and/or user provide additional information to the access management component 104 related to the geographic location associated with the consumer to facilitate determining and validating the geographic location associated with the consumer to the desired fine level of granularity.

In another aspect, when a geographic location of a consumer (or potential consumer) is validated, an object, such as a file, data packet, or token can be generated that can comprise the validated geographic information. As a request or order for an access service is processed additional information, such as type of access service, access provider, cost of the access service, and/or other information, can be stored in the object.

In accordance with an aspect, the central repository 106 can be updated with new information related to, for example, geographic location information (e.g., changes in streets or addresses), zip codes, region boundaries (e.g., changes in the boundary of a city, township, county, or state, etc.), phone numbers (e.g., phone numbers linked to addresses), names (e.g., business names linked to phone numbers and/or street addresses), etc., to facilitate evaluating the received subset of information and validating a geographic location associated with a consumer (or potential consumer).

In yet another aspect, when a geographic location of a consumer (or potential consumer) is validated, the access management component 104 can request and/or receive information related to the type of access service (e.g., DS0, DS1, etc.) desired by the consumer. The access management component 104 can automatically determine whether the desired type of access service is available from at least one of a plurality of access providers associated with the order management component 102, for the validated geographic location. If the desired type of access service is not available given the validated geographic location of the consumer, the access management component 104 can transmit a message to the sales person and/or consumer via the communication device (e.g., 112) to have the sales person and/or consumer select another type of access service that is available. If the access management component 104 determines that a desired type of access is available, the access management component 104 can automatically and dynamically determine and select an access provider that can provide the desired access service based at least in part on predefined access criteria. The predefined access criteria can relate to, for example, the geographic location associated with the consumer at which the access service is to be provided, whether a particular access provider can provide the desired access service to the geographic location associated with the consumer, cost (e.g., wholesale cost to the re-selling entity associated with the sales person) of the access service of a respective access provider, whether an access provider can provide the desired access service within the time frame desired by the consumer, whether an access provider meets or exceeds desired performance parameters for providing the desired access service or other services, preference of the consumer with regard to an access provider(s), etc. For example, the access management component 104 can select an access provider that has the lowest cost, when the access provider also meets at least the minimum standards for other predefined access criteria (e.g., can meet the desired time frame for providing the access service, can meet the performance parameters, etc.). As another example, each access criterion and/or related parameters (e.g., cost parameter, performance parameter, time frame parameter related to amount of time to provide the access service, etc.) can be respectively weighted (e.g., lowest cost criterion can be give a higher weighting than performance-data criterion), as desired, and the access management component 104 can evaluate each available access provider, based at least in part on rules created in accordance with the predefined access criteria, and a rating score can be generated for each access provider. The access management component 104 can automatically and dynamically select the access provider that has the highest rating score.

In an aspect, the central repository 106 can be updated at desired times (e.g., when notice of new information is received, and/or on a periodic basis) to store changes in information or store new information related to availability of an access service or cost of an access service. For example, the central repository 106 can be updated to include new access services being available from a particular access provider, new pricing with regard to an access service available from a particular access provider, or new or different geographic regions in which a particular access provider can provide a particular access service.

In still another aspect, when the desired access service, cost for service, and access provider have been determined with regard to a consumer's order (or request for access service which has not been submitted as an order), a request for the desired access service or an order requesting the desired access service can be generated. For instance, an order for a desired access service can be a request for the desired access service that has been submitted to be processed, and a request can identify a potentially desired access service the consumer can desire, but the request has not been submitted as an order.

In an aspect, when an order is being processed, the access management component 104 can automatically generate an access service request to facilitate provisioning the access service for the consumer. For instance, the access management component 104 can facilitate populating (e.g., autopopulating) information into the access service request where the information can be related to the access service desired by the consumer, and can comprise, for example, geographic location information, type of access service, cost of access service, access service provider, billing information, and/or other information associated with the consumer. In an aspect, the access management component 104 can access the access inventory component 108 to facilitate identifying and/or providing the desired access service to the consumer.

In yet another aspect, the access management component 104 also can facilitate routing the order for the desired access service so that the order can be further processed and provisioning can be performed to facilitate providing the desired access service from the desired access provider to the consumer in accordance with the order. In an aspect, electronic bonding (e-bonding) can be employed to facilitate routing of the order, processing of the order by the system 100, coordinated with the entity and the desired access provider, wherein e-bonding can provide a customized interface that enables communication of information related to the order between components in system 100 and/or components associated with system 100 (e.g., components associated with an access provider) to facilitate automatically performing functions associated with processing an order or providing an access service, such as, for example, automatically performing functions related to provisioning of the access service, checking the status of an order, billing for an access service, etc. The access management component 104 can facilitate billing the consumer for the access service provided to the consumer.

Referring again to a request related to an access service, if a request is received, but is not submitted as an order for the access service by the consumer, the access management component 104 can monitor and track the amount of time that the request associated with the consumer is pending to facilitate reducing errors with regard to cost or provisioning of access service to a consumer. For instance, a request that is not processed as an order can contain cost for an access service from a service provider. However, since cost of an access service from an access service provider and/or the availability of the access service can change over time, the access management component 104 can determine that the cost and/or availability of an access service is expired or no longer valid after a predetermined amount of time (e.g., 1 week, 1 month, 3 months, 6 months, . . . ) based at least in part on the predefined access criteria. If a predetermined amount of time has elapsed without the request being processed as an order, the access management component 104 can automatically determine that the cost of the access service and/or availability of the access service is no longer valid or to be relied upon, and can highlight, remove, or otherwise indicate that the cost of the access service and/or availability of the access service is/are no longer valid. If the request is processed as an order for the desired access service prior to the expiration of a predetermined amount of time, the access management component 104 can determine that the cost of the access service and/or availability of the access service is valid, and can be displayed as valid and/or otherwise indicated as valid.

Referring again to the central repository 106, the central repository 106 can comprise nonvolatile memory and/or volatile memory. The nonvolatile memory can include, but is not limited to, flash memory (e.g., single-bit flash memory, multi-bit flash memory), read-only memory (ROM), mask-programmed ROM, programmable ROM (PROM), Erasable PROM (EPROM), Ultra Violet (UV)-erase EPROM, one-time programmable ROM, electrically erasable PROM (EEPROM), phase change memory (PCM), and/or nonvolatile RAM (e.g., ferroelectric RAM (FeRAM)). Volatile memory can include, but is not limited to, random access memory (RAM), static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

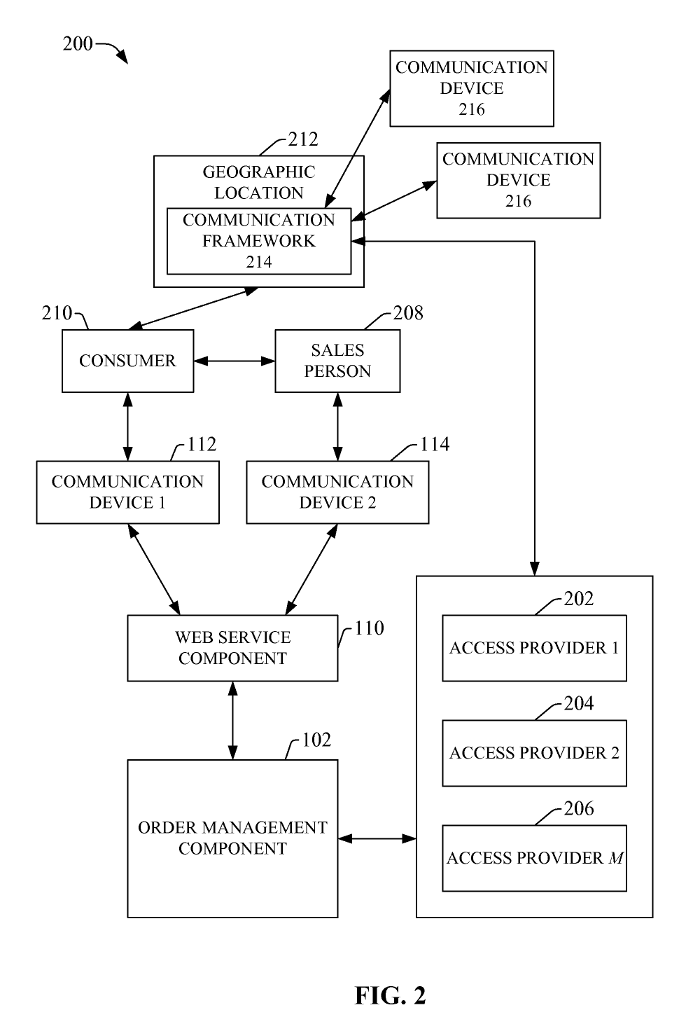

Referring to FIG. 2, depicted is a block diagram of a system 200 that can facilitate efficient ordering and provision of access services in accordance with an aspect of the disclosed subject matter. In an aspect, the system 200 can comprise an order management component 102 that can facilitate efficient and automated processing of orders for access services (e.g., wireless communication access, wired communication access) from access providers, such as access provider 1 (202), access provider 2 (204), through access provider M (206), where M can be virtually any desired integer. The order management component 102 can be associated with an entity that can purchase access services at a wholesale cost and can re-sell the access services to consumers that contract with the entity. A sales person(s) 208 associated with the entity and order management component 102 and/or a consumer 210 can utilize communication devices 112 and/or 114 (e.g., computer, mobile phone, etc.) to interact with the order management component 102 via a web service component 110 to create an order for a desired access service from a desired access provider (e.g., 202, 204, or 206) to facilitate provision of an access service to the consumer. It is to be appreciated and understood that the order management component 102, web service component 110, and communication device 1 (112) and communication device 2 (114) each can be the same or similar as, and/or can comprise the same or similar functionality as, respective components, such as more fully described herein, for example, with regard to system 100.

In an aspect, the sales person 208 can communicate directly with the consumer 210 and/or via communication devices (e.g., 112, 114) to obtain a subset of information, comprising at least a portion of geographic location information associated with the consumer 210 (e.g., geographic location 212 where the access service is desired by the consumer). The order management component 102 can automatically perform an address validation to validate the geographic location associated with the consumer 210 and/or can automatically retrieve additional geographic location information associated with the consumer 210 (e.g., from central repository 106, as illustrated in FIG. 1) to facilitate generating and validating the geographic location, having a fine granularity (e.g., specific to a room number, floor number, and/or building number, as applicable, in addition to a street address, associated with the consumer 210) associated with the consumer 210, based at least in part on the received subset of information, to facilitate reducing errors related to orders for access services, reducing the amount of time to process orders for access services, accurately determining access service availability, and accurately pricing a desired access service.

The order management component 102 can automatically and dynamically determine the availability of a desired access service, pricing of the access service, and the access provider that will provide the access service, based at least in part on the validated geographic location 212 associated with the consumer 210. In another aspect, the order management component 102 can generate an order and can automatically enter (e.g., autopopulate) information into an access service request (e.g., as part of the order) to request the access service. The order management component 102 can employ e-bonding between the desired access provider (e.g., 202, 204, or 206) and the order management component 102 to facilitate automatically communicating information related to processing the order between the desired access provider (e.g., 202, 204, or 206) and the order management component 102, which can facilitate provisioning of the access service and billing the consumer 210 for the access service. The desired access service provider (e.g., 202, 204, or 206) can provide the access service to the communication framework 214 at the desired geographic location 212 associated with the consumer 210. The communication framework 214 can comprise various components (not shown), such as a computer(s), a server(s), a router(s), an access point(s) (e.g., femtocell access point), a broadband component(s) (e.g., components that can facilitate communication of data at broadband speed), etc., to facilitate communication by a communication device(s) 216 (e.g., computer(s), mobile phone(s), personal digital assistant(s) (PDA(s)), electronic game(s), etc.) connected to the communication framework 214 via a wireless or wired connection.

It is to be appreciated and understood that the number of communication devices (e.g., 112, 114, 216) depicted in system 200 is for example purposes only, and for brevity and clarity. The system 200 can employ the number of communication devices depicted in the system 200, more than the number of communication devices depicted in the system 200, or less than the number of communication devices depicted in the system 200, as desired.

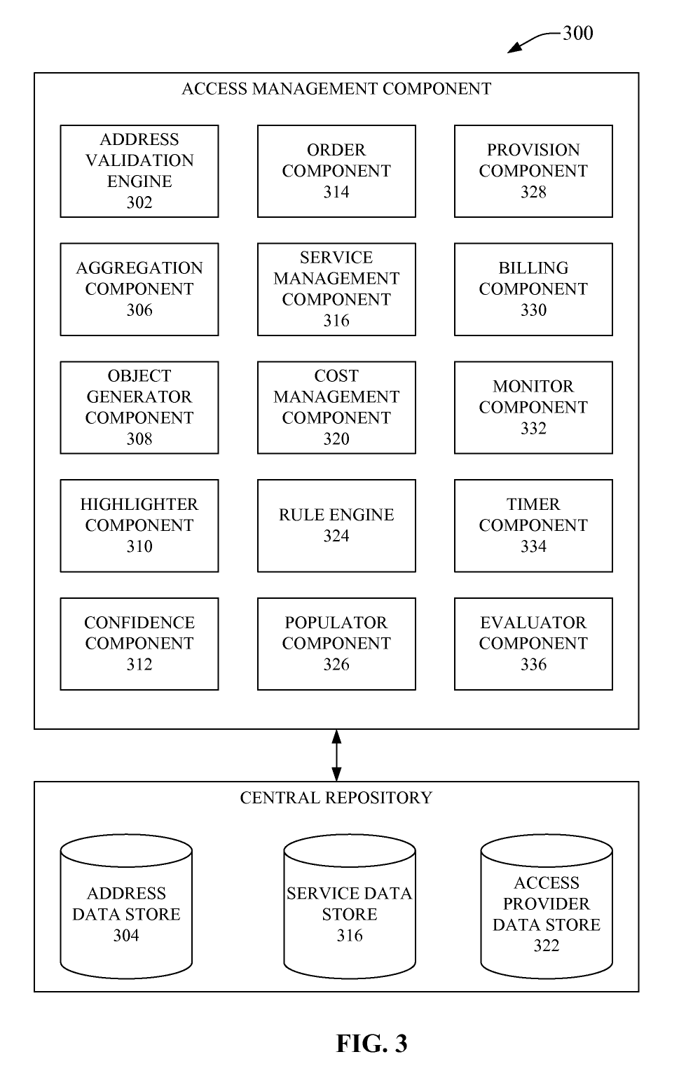

FIG. 3 illustrates a block diagram of a system 300 that can facilitate processing of orders for access services in accordance with an aspect of the disclosed subject matter. In an aspect, the system 300 can be included in an order management component 102 (e.g., illustrated in FIG. 1 and described herein). In one aspect, the system 300 can include an access management component 104 that can efficiently manage processing of orders for access services provided to consumers. The access management component 104 can be associated with a central repository 106 that can store and provide information related to processing orders for access services. It is to be appreciated and understood that the access management component 104 and central repository 106 each can be the same or similar as, and/or can comprise the same or similar functionality as, respective components, such as more fully described herein, for example, with regard to system 100.

In an aspect, the access management component 104 can comprise an address validation engine 302 that can receive a subset of information, including at least a portion of geographic location information, associated with a consumer that desires or potentially desires an access service. The address validation engine 302 can analyze the received subset of information to determine what geographic location information has been provided, what geographic location information is still desired (e.g., needed) to have a valid geographic location of a fine level of granularity (e.g., specific to a sub-address level, such as a room number, floor number, or building identifier or number, as applicable), based at least in part on the received subset of information. The address validation engine 302 also can access an address data store 304 contained in the central repository 106 to facilitate automatically generating and/or validating a geographic location of a consumer. For instance, the address data store 304 can contain information, such as information related to street addresses, cities or other regional entities, states, zip codes, business names, personal names, phone numbers, web site addresses respectively associated with businesses or other entities, etc., that can facilitate generating and/or validating a geographic location of a consumer. The address validation engine 302 can retrieve desired information from the address data store 304, based at least in part on the subset of information, and can automatically validate the geographic location of the consumer in real time (or at least can determine that a geographic location cannot be validated based on a current subset of information).

For example, a consumer can provide a street address number and name (e.g., associated with a business of the consumer) where the consumer desires an access service to be provided and a phone number (e.g., business phone number) associated with that street address to a sales person. The street address information can be such that it is not of a sufficiently fine granularity for address validation purposes. The sales person can provide the street address information and phone number to the access management component 104. The address validation engine 302 can analyze the street address information and phone number and can retrieve additional information from the address data store 304 that can facilitate generating one or more geographic locations that potentially can be a valid geographic location having fine granularity. For instance, the address validation engine 302 can perform a reverse look up on the phone number to facilitate obtaining additional geographic information (e.g., floor number, room number, building number, as applicable) associated with the consumer's street address, and/or can obtain city, state, and/or zip code information associated with the street address using data stored in the address data store 304. The generated geographic location(s) can be presented to the consumer and/or sales person to facilitate selecting and/or validating the geographic location of the consumer. The validated geographic location of the consumer can be stored in the address data store 304 and also can be stored in a file, data packet, or token that can be associated with an order or request for an access service.

In accordance with another aspect, the access management component 104 can contain an aggregation component 306 that can facilitate collecting, aggregating, and/or organizing data received by the access management component 104 to facilitate processing orders for access services, as desired. The received data, as aggregated and/or organized, can be stored in the central repository 106 or other desired data storage, and/or provided to another component associated with system 300.

In still another aspect, the access management component 104 can include an object generator component 308 that can generate an object(s), such as a file, data packet, or token, that can contain information related to a validated geographic information, type of access service, access provider, cost of the access service, and/or other information, to facilitate processing of an order for an access service of a consumer. For instance, the object generator component 308 can generate an object when a geographic location associated with a consumer is validated. As the order or request of the consumer is further processed, additional information, such as type of access service, access provider, and/or cost of the access service, can be stored in the object.

In yet another aspect, the access management component 104 can contain a highlighter component 310 that can facilitate respectively highlighting or emphasizing geographic locations presented to a consumer and/or sales person to facilitate validating a geographic location of a consumer. The highlighter component 310 can receive confidence level information from a confidence component 312, where the confidence level information can relate to the level of confidence in the accuracy of geographic information presented to the consumer and/or sales person. For example, the color red can be used to highlight or flag geographic location information that has a low confidence level; the color yellow can be used to highlight or flag geographic location information that has a moderate confidence level; and the color green can be used to highlight or flag geographic location information that has a high confidence level, as the information can most likely be accurate and/or confirmed. The confidence component 312 can employ probabilistic graphical models (e.g., Dempster-Shafer networks, Bayesian networks), classifiers (e.g., support vector machines (SVMs)), and/or a rule-based engine to facilitate inferring or determining a confidence level for a piece of geographic location information.

In an aspect, the access management component 104 can include an order component 314 that can facilitate generating orders or requests (e.g., an unsubmitted order) for access services. The order component 314 can facilitate entering and/or storing information associated with the consumer (e.g., validated geographic location, payment information, personal information, etc.), a desired access service, an access provider, cost of the access service, etc., into the generated orders or requests.

In still another aspect, the access management component 104 also can contain a service management component 316 that can facilitate identifying an available access service(s) that can be provided (e.g., potentially provided) to a consumer at the geographic location of the consumer based at least in part on the validated geographic location of the consumer. The service management component 316 can analyze a validated geographic location of the consumer and/or information from the consumer regarding the type of access service desired, where the validated geographic location can be contained in an object generated by the object generator component 308, for example. The service management component 316 can be associated with and can access a service data store 318 in the central repository 106 to retrieve information related to access services, such as respective geographic locations or regions to which respective access services can be provided by respective access providers. Based at least in part on the information retrieved from the service data store 318 and the validated geographic location information of the consumer, the service management component 316 can automatically and dynamically identify available access services and available access providers for the validated geographic location.

The access management component 104 can further include a cost management component 320 that can facilitate automatically and dynamically identifying and selecting an access provider to provide the desired available access service based at least in part on predefined access criteria. In an aspect, the cost management component 320 can receive the order or request, and/or object associated with the order or request, related to the consumer desiring an access service, and can analyze information, such as the validated geographic location, desired available access service and/or preference of the consumer with regard to an access provider(s), associated with the order or request, and/or stored in the object, and can access an access provider data store 322 in the central repository 106 to retrieve and analyze information related to respective access providers, including information regarding respective costs (e.g., wholesale costs) for the access service (e.g., in relation to the geographic location of the consumer), respective amounts of time to provide the access service, respective performance data, etc., of the access providers. The cost management component 320 also can access a rule engine 324 that can comprise the parameters to be employed using the predefined access criteria and the cost management component 320 operating in conjunction with the rule engine 324 can facilitate automatically and dynamically selecting an access provider to provide the desired access service. For instance, the rule engine 324 can comprise defined rules related to an access-provider specific choice, access-service availability check, least-cost access-provider choice, and/or other defined rules that can facilitate implementing the predefined access criteria.

For example, the cost management component 320 and rule engine 324 can facilitate identifying and selecting an access provider to provide the desired access service to the consumer, where the access provider can be the one that has the lowest cost in providing the access service, while also meeting other predefined access criteria (e.g., required time frame to provide the access service to the consumer, meets specified performance parameters, etc.). As another example, the cost management component 320 and rule engine 324 can facilitate identifying and selecting an access provider based at least in part on the predefined access criteria, where each access criterion can be given a respective weight (e.g., low cost criterion can be given more weight than another access criterion), which can be the same or different from another access criterion, and each access provider can be given a ratings score based in part on the respective cost and performance data of the respective access providers when that data is analyzed in light of the predefined access criteria and the respective weighting.

In still another aspect, the access management component 104 can employ a populator component 326 that can facilitate automatically populating fields in an access service request associated with an order or request. The populator component 104 can automatically enter respective information into respective fields of the access service request, where the information can include, for example, the validated geographic location to which the access service is to be provided, the access service that is requested, the name and/or other information associated with the access provider, the date and time by which the access service is to be provided, cost (e.g., wholesale cost to be incurred by the re-selling entity) of the access service, the name of the consumer, etc. The information that is autopopulated in the fields of the access service request can be obtained from the access inventory component 108 (e.g., illustrated in FIG. 1), the order or request, and/or the object associated with the order or request.

The access management component 104 can comprise a provision component 328 that can facilitate provisioning the desired access service for the consumer. In an aspect, the provisioning component 104 can employ e-bonding to facilitate automatically exchanging information between the order management component 102 and an access provider(s) (e.g., 202, 204, or 206) and/or automatically performing functions associated with processing an order or providing the access service to a consumer (e.g., checking the status of an order, billing for an access service, etc.), to facilitate provisioning the access service. The access management component 104 also can utilize a billing component 330 that can facilitate generating and/or providing billing for the access service to the consumer. In an aspect, the billing component 330 can employ e-bonding to facilitate automatically generating the respective billings for consumers.

In yet another aspect, the access management component 104 can comprise a monitor component 332 that can monitor a request for access service associated with a consumer, where the request has not been submitted to be processed as an order. The request can contain time-sensitive information, such as, for example, cost for access service and/or availability of access service. The monitor component 332 can monitor received requests and can indicate to a timer component 334 that a request has been received. The timer component 334 can facilitate time stamping the request for access service at the time the request is generated and the time stamp can be associated with the request and stored in a data store. In addition to, or as an alternative to, time stamping the request, the timer component 334 can maintain a timer(s) or clock resource(s) that can facilitate tracking respective amounts of time that respective requests are pending. The access management component 104 also can include an evaluator component 336 that can evaluate the information associated with the request and the amount of time that the request has been pending based in part on information obtained from the timer component 334 and can render a determination regarding whether respective pieces of information contained in the request are valid or not based at least in part on predefined time criteria. The predefined time criteria can provide that a specified cost for an access service contained in a pending request is not valid once a respective predetermined amount of time has elapsed and/or availability of an access service can no longer be trusted as valid information after a respective predetermined amount of time has elapsed, where the respective predetermined amount of time for each piece of information can be the same or different for respective parameters. The evaluator component 336 can evaluate the information in a pending request when the pending request is accessed, for example. If a piece of information in a request is determined to be no longer valid, the evaluator component 336 can communicate the invalidity of the piece of information to the order component 314, which can facilitate communicating with other components (e.g., object generator component 308, service management component 316, cost management component 320) to obtain new and valid information to replace the invalid information.

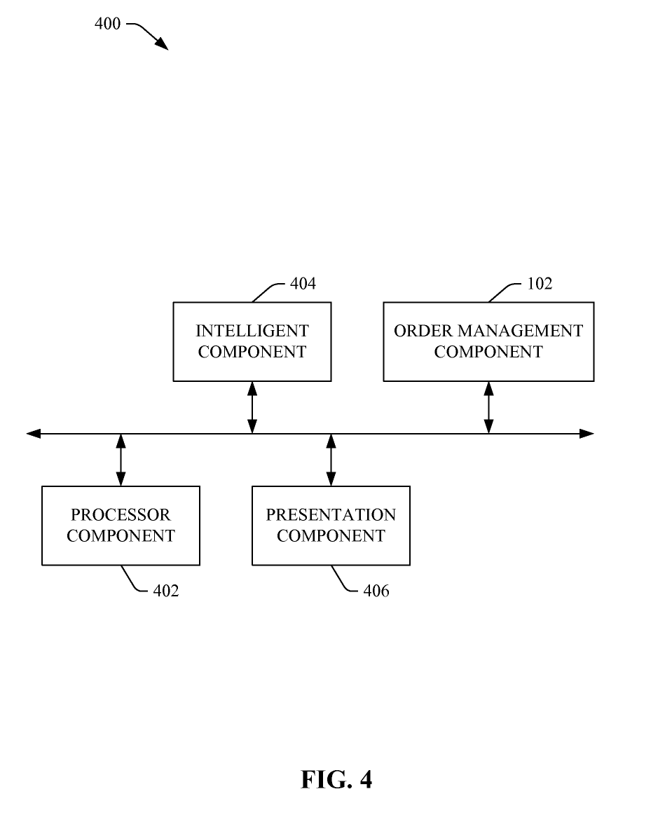

Referring to FIG. 4, depicted is a block diagram of a system 400 that can employ intelligence to facilitate processing orders for access services in accordance with an embodiment of the disclosed subject matter. System 400 can include an order management component 102 that can facilitate efficiently processing orders for access services. It is to be appreciated that the order management component 102 can be the same or similar as respective components, and/or can contain the same or similar functionality as respective components, as more fully described herein, for example, with regard to system 100, system 200, and system 300.

The system 400 can further include a processor component 402 that can be associated with the order management component 102 and other components via a bus. In accordance with an embodiment of the disclosed subject matter, the processor component 402 can be a typical applications processor that can manage communications and run applications. For example, the processor component 402 can be a processor that can be utilized by a computer or other electronic device. The processor component 402 can generate and/or execute commands to facilitate performing operations associated with the order management component 102.

The system 400 also can include an intelligent component 04 that can be associated with the order management component 102 and/or other components associated with system 400 to facilitate analyzing data, such as current and/or historical information related to processing orders for access services, and, based at least in part on such information, can make an inference(s) and/or a determination(s) regarding, for example, whether a geographic location of a consumer is validated, identifying a portion of a geographic location of a consumer, a confidence level(s) regarding accuracy of information identifying a geographic location, availability of an access service, selecting an access provider, a rating score(s) of an access provider(s), validity of time-sensitive information associated with an order, etc.

For instance, based at least in part on current and/or historical evidence related to processing orders for access services, the intelligent component 404 can infer a portion of a geographic location associated with a consumer or the validity of a geographic location of a consumer. Based at least in part on the inference with respect to such data by the intelligent component 404, the order management component 102 can facilitate validating a geographic location of a consumer or modifying a geographic location of a consumer to facilitate validating a geographic location of a consumer.

It is to be understood that the intelligent component 404 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data (e.g., historical data), whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . can be employed in connection with performing automatic and/or inferred action in connection with the disclosed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

System 400 also can include a presentation component 406, which can be connected with the processor component 402. The presentation component 406 can provide various types of user interfaces to facilitate interaction between a user and any component coupled to the processor component 402. As depicted, the presentation component 406 is a separate entity that can be utilized with the processor component 402 and associated components. However, it is to be appreciated that the presentation component 406 and/or similar view components can be incorporated into the processor component 402 and/or a stand-alone unit. The presentation component 406 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to and/or incorporated into the processor component 402.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

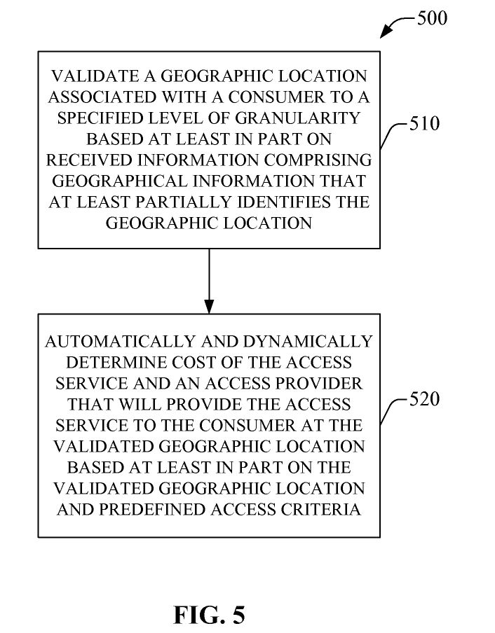

In view of the example systems described herein, example methodologies that can be implemented in accordance with the disclosed subject matter can be better appreciated with reference to flowcharts in FIGS. 5-9. For purposes of simplicity of explanation, example methodologies disclosed herein are presented and described as a series of acts; however, it is to be understood and appreciated that the claimed subject matter is not limited by the order of acts, as some acts may occur in different orders and/or concurrently with other acts from that shown and described herein. For example, a methodology disclosed herein could alternatively be represented as a series of interrelated states or events, such as in a state diagram. Moreover, interaction diagram(s) may represent methodologies in accordance with the disclosed subject matter when disparate entities enact disparate portions of the methodologies. Furthermore, not all illustrated acts may be required to implement a methodology in accordance with the subject specification. It should be further appreciated that the methodologies disclosed throughout the subject specification are capable of being stored on an article of manufacture to facilitate transporting and transferring such methodologies to computers for execution by a processor or for storage in a memory.

FIG. 5 presents a flowchart of an example methodology 500 for efficiently processing orders for access services in accordance with an aspect of the disclosed subject matter. At 502, a geographic location associated with a consumer can be validated to a specified level of granularity based at least in part on received information comprising geographical information that at least partially identifies the geographic location. In an aspect, an access management component 104 can employ an address validation engine 302 that can evaluate received information, such as the geographical information (e.g., street address associated with the consumer) and/or a phone number associated with the geographic location, and can retrieve other information from an address data store 304 and/or access other resources (e.g., the Internet, applications, etc.) to facilitate validating the geographic location of the consumer to a specified level of granularity (e.g., sub-address level, such as a room number, floor number, and/or building identifier or number, associated with the geographic location of the consumer) in real time. In an aspect, the address validation engine 302 can provide one or more potential geographic locations to the consumer to facilitate selection of a geographic location that can be validated to the specified level of granularity. The access management component 104 can generate and provide respective confidence levels, for example, using respective highlight indicators (e.g., respective color coding) for each piece of geographic location information presented to the consumer to facilitate validation of the geographic location of the consumer.

At 504, cost of the access service and an access provider that will provide the access service to the consumer at the validated geographic location can be automatically and dynamically determined based at least in part on the validated geographic location and predefined access criteria. In an aspect, the access management component 104 can employ a rule engine 324 that utilizes one or more rules that are created in accordance with the predefined access criteria, where the rule(s) can be applied to the information contained in the order for access service to facilitate automatically and dynamically determining the cost for the access service and the access provider that is to provide the access service to the validated geographic location. The order for access service can be further processed (e.g., employing e-bonding between the access management component 104 and the access provider) to facilitate automatically provisioning the access service and billing the consumer.

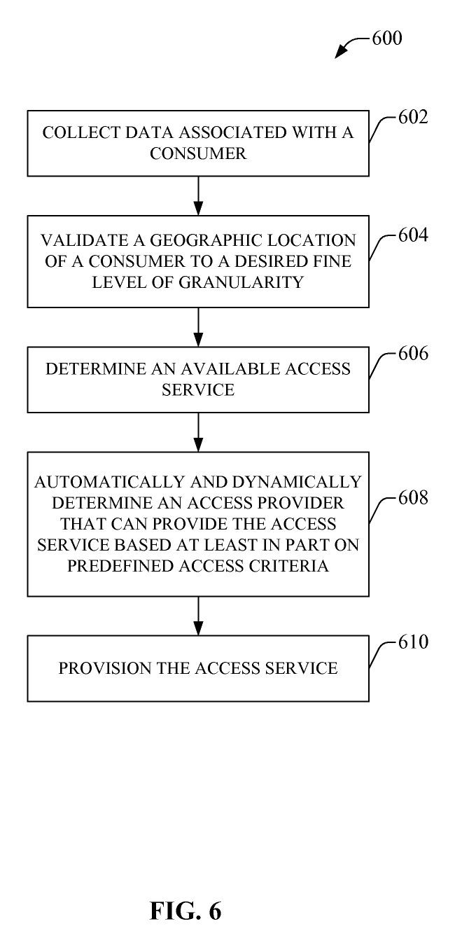

FIG. 6 illustrates a flowchart of an example methodology 600 that can facilitate processing orders for access services in accordance with an aspect of the disclosed subject matter. At 602, data associated with a consumer can be collected. In an aspect, data (e.g., a subset of data), such as geographical location data (e.g., at least a portion of an address) for a location where a consumer desires an access service, personal information associated with a consumer, business-related information associated with a consumer, etc., can be collected, for example, by an order management component 102, to facilitate determining a valid geographical location of the consumer and processing an order for an access service desired by a consumer.

At 604, a geographic location of a consumer can be validated to a desired fine level of granularity (e.g., validated to a sub-address level). In an aspect, the collected data can be evaluated and additional geographic location information can be retrieved from an address data store 304 based at least in part on the collected data to facilitate generating and determining a validated geographical location of a consumer that is specified to a desired fine level of granularity (e.g., location identified to a specific room number, floor number, building number, etc., as applicable) in real time. A validated geographical location (e.g., validated to a desired fine level of granularity) for a consumer desiring an access service can facilitate reducing order errors, reducing errors in determining cost of the access service, and reducing the amount of time to process orders.

At 606, an available access service can be determined. In an aspect, a consumer can specify a desired access service. The access management component 104 can determine whether a desired access service is available based at least in part on the validated geographic location of the consumer. If an access service initially desired by a consumer is not available, the access management component 104 can facilitate prompting the consumer to provide a different desired access service from available access services for the validated geographical location, and the access management component 104 can facilitate determining an available access service that is desired by the consumer.

At 608, an access provider that can provide the access service can be automatically and dynamically determined based at least in part on predefined access criteria. In one aspect, the access management component 104 can facilitate automatically determining which access providers are available to provide the desired access service to the validated geographic location, and automatically and dynamically identifying and selecting an access provider to provide the access service to the consumer at the validated geographical location based at least in part on the predefined access criteria. For example, an access service provider that provides the access service at lowest cost while meeting other predefined access criteria can be selected, or an access service provider that has a highest rating score determined based at least in part on respectively weighted parameters (e.g., cost, performance, etc.) associated with providing access services.

At 610, the access service can be provisioned. In an aspect, the access management component 104 and the selected access provider (e.g., 202, 204, or 206) can employ e-bonding to facilitate communicating information related to processing the order for the access service and provisioning the access service to each other to facilitate providing the access service to the consumer at the validated geographic location of the consumer. The access management component 104 and access provider also can utilize e-bonding to facilitate billing the consumer for the access service.

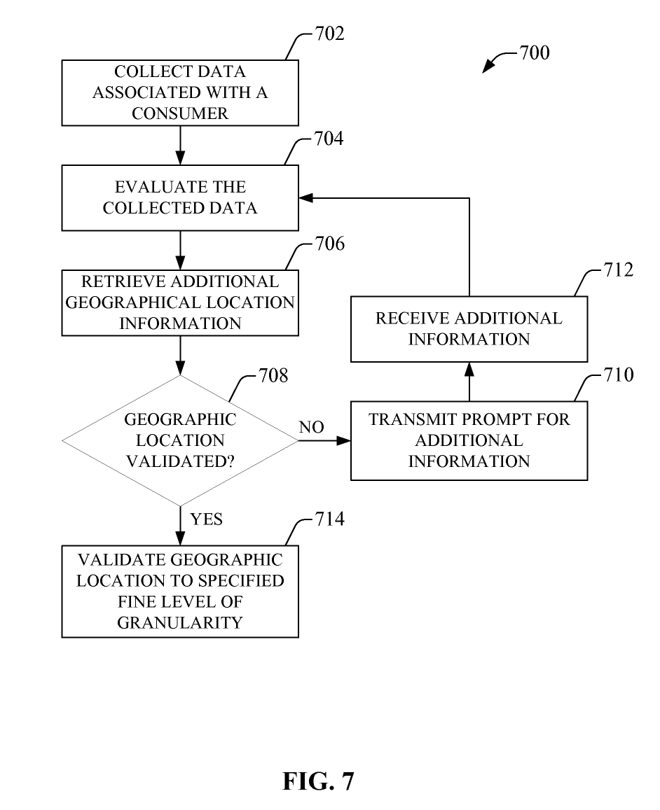

FIG. 7 illustrates a flowchart of an example methodology 700 that can validate a geographical location of a consumer to facilitate processing orders for access services in accordance with an aspect of the disclosed subject matter. At 702, data (e.g., subset of information) associated with a consumer can be collected. In an aspect, data, such as geographical location data (e.g., at least a portion of an address) for a location where a consumer desires an access service, personal information associated with a consumer, business-related information associated with a consumer, etc., can be collected, for example, by an order management component 102, to facilitate determining a valid geographical location of the consumer and processing an order for an access service desired by a consumer.

At 704, the collected data (e.g., subset of information) can be evaluated. In an aspect, the collected data can be evaluated to facilitate determining a valid geographical location for the consumer. For instance, the collected data can be evaluated to determine what portions of the geographical location have been provided and to determine whether the geographical location can be validated to a specified fine level of granularity (e.g., location identified to a specific room number, floor number, building number, etc., as applicable).

At 706, additional geographical location information can be retrieved. In an aspect, additional geographical location information that is related to, or is potentially related to, the geographical location of the consumer can be retrieved from an address data store 304 based at least in part on the collected data, where the additional geographical information can be presented to the consumer and/or sales person along with at least a portion of the collected data (e.g., portion of the geographical location provided by the consumer) to facilitate determining and validating a geographical location of the consumer to the specified fine level of granularity. For instance, a portion of an address and/or other information (e.g., phone number of the consumer) can be received by the access management component 104 from a consumer. The received information can be utilized to identify and retrieve other information from the address data store 304 to facilitate generating a geographical location having a specified fine level of granularity to facilitate validating a geographical location having the specified fine level of granularity.

At 708, a determination can be made regarding whether a geographical location is validated with regard to the consumer. In an aspect, the access management component 104 can facilitate determining, in real time, whether a geographical location (e.g., one of the geographical locations presented to the consumer and/or sales person) is validated as being accurate to the specified fine level of granularity. The access management component 104 can render a determination regarding validity of a geographical location for the consumer based at least in part on its own evaluation and/or an indication received from the consumer and/or sales person (e.g., selection of one of the presented geographical locations). For example, the access management component 104 can generate one or more potential geographic locations of the consumer based at least in part one the collected data and retrieved data from the address data store 304, and can present the potential geographic location(s) to the consumer and/or sales person to facilitate validating a geographic location of the consumer. The consumer can select a geographic location that can be validated to the specified fine level of granularity.

If it is determined that the geographical location is not valid, at 710, a prompt for additional information can be transmitted. In an aspect, the access management component 104 can generate and transmit a message to prompt the consumer and/or sales person to provide additional information (e.g., geographic location information) to facilitate validating a geographic location of the consumer. At 712, the additional information can be received. In an aspect, the additional information can be received by the access management component 104. At this point, methodology 700 can return to reference numeral 704, where the additional information and initial subset of information can be evaluated, and methodology 700 can proceed from that point.

If, at 708, it is determined that the geographic location is validated to the specified fine level of granularity, at 714, the geographic location can be validated to the specified level of granularity. At 716, the validated geographic location of the consumer can be stored. In an aspect, the validated geographic location can be stored in the address data store 304 and/or can be stored in an object (e.g., token) that can be associated with an order or request for access service associated with the consumer. The order can be further processed by generating an access service request, and the access service can be provisioned. The consumer also can be billed for the access service in accordance with the retail cost for the access service as provided in the order or associated contract.

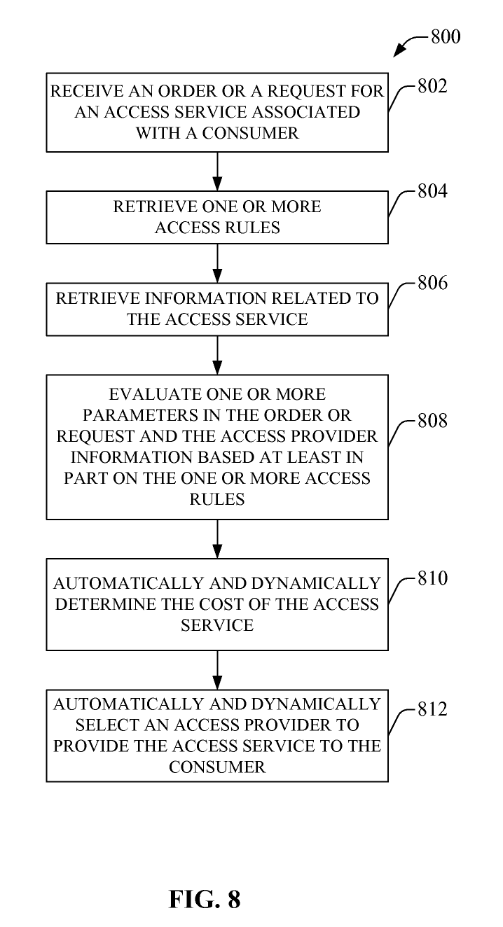

FIG. 8 depicts a flowchart of an example methodology 800 that can automatically and dynamically determine cost of an access service and select an access provider to facilitate efficient processing of an order for an access service in accordance with an aspect of the disclosed subject matter. At 802, an order or a request for an access service associated with a consumer can be received. In an aspect, an access management component 104 can generate an order or a request for an access service desired by a consumer. A geographic location of the consumer where the access service it to be provided can be included in the order or request. The geographic location can be a validated geographic location with specific information regarding the location down to a desired fine level of granularity to facilitate accurate and efficient order processing. The order or request also can include other parameters, such as access-provider preference of the consumer, time frame for starting the access service as desired by the consumer, time period or contract period for the access service, etc.

At 804, one or more access rules can be retrieved. In an aspect, the access management component 104 can access a rules engine and the one or more access rules can be retrieved. The one or more access rules can be based at least in part on predefined access criteria to facilitate efficient order processing and determining the lowest cost for the access service while still meeting other desired access criteria.

At 806, information related to the access service can be retrieved. In an aspect, the access management component 104 can retrieve information related to the access service and access providers that are available to provide the access service to the validated geographic location of the consumer, such as respective costs for the access service from respective access providers, respective availability of respective access providers with respect to the access service, respective performance data of access providers, from a access provider data store 322.

At 808, the one or more parameters in the order or request and the access provider information can be evaluated based at least in part on the one or more access rules. The access management component 104 and/or rules engine can facilitate evaluating the parameters in the order or request and the access provider information retrieved from the access provider data store 322.

At 810, the cost of the access service can be automatically and dynamically determined. Based at least in part on the evaluation of the parameters and access provider information in accordance with the one or more access rules, the cost of an access service can be automatically and dynamically determined and entered (e.g., cost field can be autopopulated with the cost value) into the order or request to facilitate processing the order or request.

At 812, automatically and dynamically select an access provider to provide the access service to the consumer. Based at least in part on the evaluation of the parameters and access provider information in accordance with the one or more access rules, an access provider can be automatically and dynamically selected, and information related to the selected access provider can be entered (e.g., access-provider-identifier field can be autopopulated with the identifier value, such as name or number associated with the access provider) into the order or request to facilitate processing the order or request. It is to be appreciated and understood that the cost of the access service and the access provider that is to provide the access service can be determined at the same or substantially the same time.

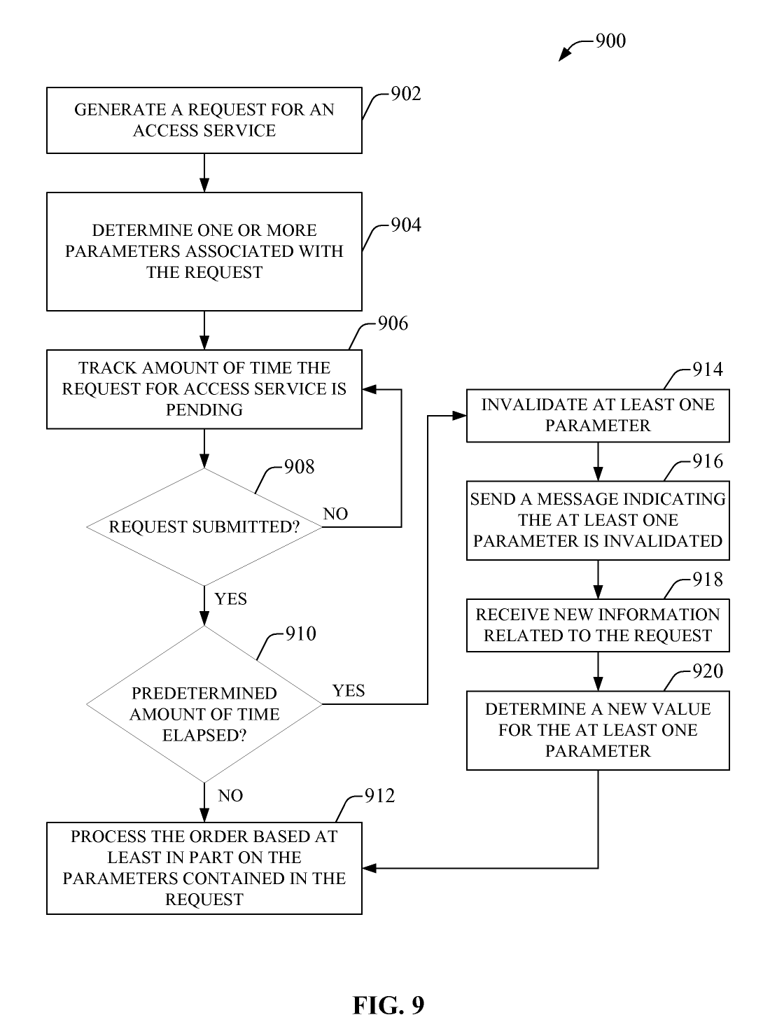

FIG. 9 depicts a flowchart of an example methodology 900 that can manage pending requests for access services to facilitate efficient order management related to access services in accordance with an aspect of the disclosed subject matter. At 902, a request for an access service can be generated. In an aspect, an access management component 104 can facilitate generating a request for an access service for a consumer. The request can comprise information related to the consumer, such as a validated geographic location at which the access service is desired, personal and/or professional information associated with the consumer, the type of access service desired, etc. It is to be appreciated and understood that a request for access service is not an order for access service, but rather is or can comprise a price quote related to access service, although the request can become an order when submitted to be processed so that the access service is provided to the consumer.

At 904, one or more parameters (e.g., cost of the access service, availability of access service) associated with the request can be determined. In one aspect, the access management component 104 can facilitate automatically and dynamically determining various parameters for the request, such as the cost of the access service and an access provider that can provide the access service to the consumer at the validated geographic location if the request becomes an order and is processed. The request can contain the cost of the access service to the consumer and/or the cost of the access service to the re-selling entity that is managing the request, although, as desired, the cost to the entity may not be included if the consumer or others besides the entity and the entity's employees may have access to the request, so that the consumer is not made aware of the cost of the access service to the entity.

At 906, the amount of time the request for access service is pending can be tracked. In an aspect, the access management component 104 can employ a timer that can track the amount of time the request is pending and/or the request can be time stamped with the date and time that the request was generated and/or the one or more parameters were determined.

At 908, a determination can be made regarding whether the request for access service has been submitted as an order for access service. If the request for access service has not been submitted as an order, methodology 900 can return to reference numeral 906, where the request can remain pending and the amount of time can continue to be tracked either actively using a timer or passively with the time stamp on the request.

If, at 908, it is determined that the request for access service has been submitted as an order for access service, at 910, a determination can be made regarding whether a predetermined amount of time has elapsed since the request was generated and/or since the one or more parameters were determined. For instance, the access management component 104 can evaluate information from the timer or can compare the current date and time to the date and time on the time stamp associated with the request to determine the amount of time that has elapsed. Respective predetermined amounts of time can be applied with respect to determining the validity of the parameters in the request (e.g., cost of the access service, the availability of the access service). If it is determined that a predetermined amount of time has not elapsed, at 912, the order can be processed based at least in part on the parameters contained in the request (e.g., request can be submitted as an order and the order for access service can be processed based at least in part on the parameters, such as the cost of access service, and availability of the access service, as contained in the request).

If, at 910, it is determined that a respective predetermined amount of time has elapsed for at least one parameter associated with the request for access service, at 914, the at least one parameter can be invalidated. In an aspect, the access management component 104 can invalidate any parameter that is invalidated due to a respective predetermined amount of time elapsing with respect to the parameter(s).

At 916, a message indicating the at least one parameter is invalidated can be sent. In an aspect, the access management component 104 can send a message to a user (e.g., sales person, consumer) to notify the user that a parameter(s) is no longer valid. At 918, new information related to the request can be received. As desired, new information related to the request and parameter(s) (e.g., invalidated parameter) can be obtained. The new information can be information from the user and/or information, such as cost of the access service, availability of an access service provider, and/or a desired access service provider (e.g., access provider that provides the access service at the lowest cost), that can be retrieved from the central repository 106 or other resources. At 920, a new value for the at least one parameter can be determined. In one aspect, a new value (e.g., cost for access service, identifier of an access provider) can be automatically and dynamically determined to facilitate processing the request as an order when submitted. At this point, methodology 900 can proceed to reference numeral 912, and methodology 900 can proceed from that point to process the order based at least in part on the parameters, including the at least one new parameter, in the request now being submitted as an order. Tracking the amount of time a request and parameters associated therewith are pending, and invalidating outdated parameters in a request can facilitate reducing order errors, increase revenue (e.g., by not processing a request with inaccurate pricing for access services), and/or reduce the amount of time to process orders (e.g., reduce or eliminate order delays related to an access provider that is no longer available at the time the request is submitted as an order).

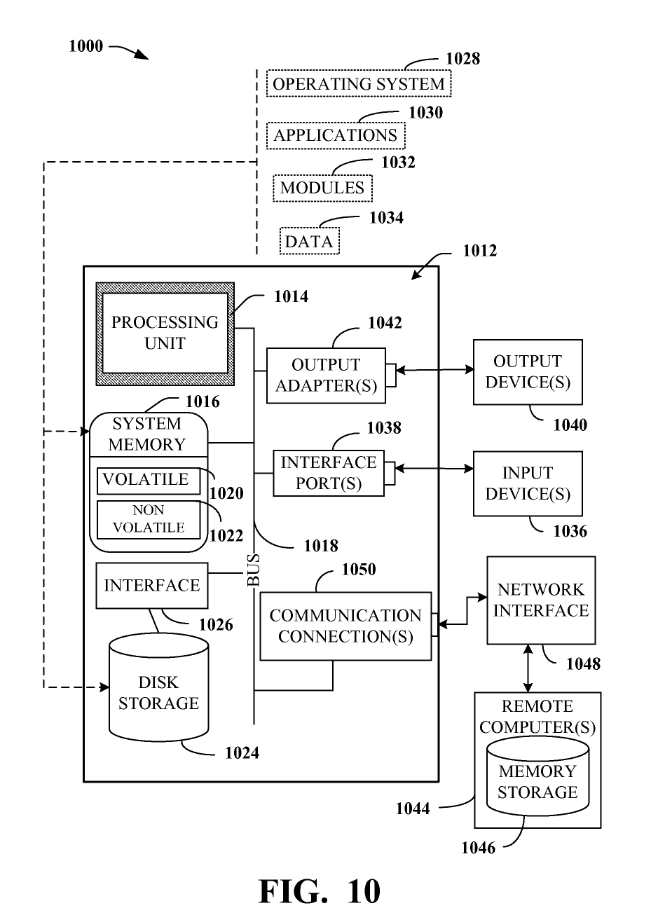

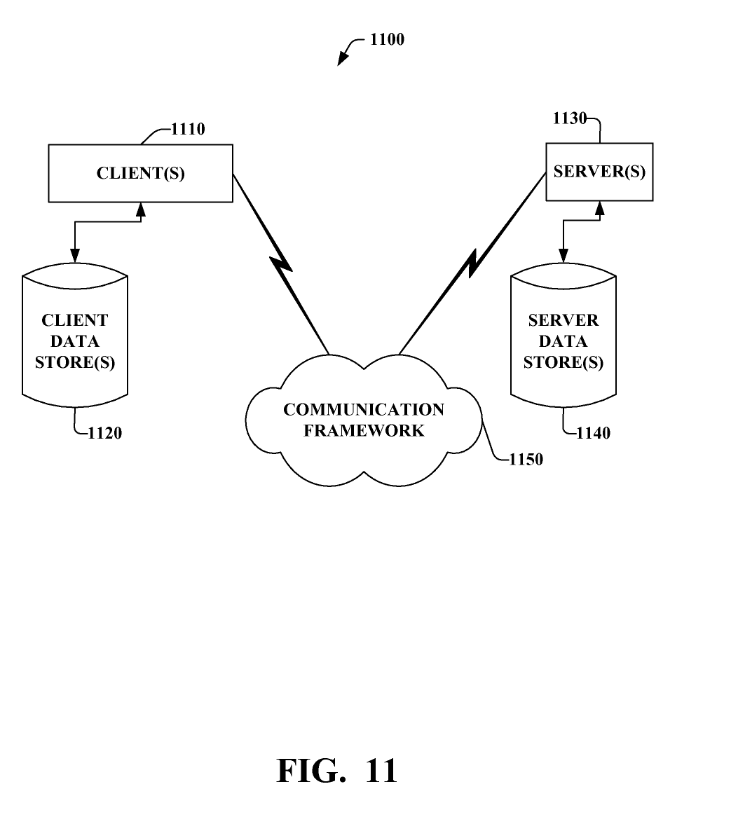

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 10, a suitable environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example, a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used, such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the subject innovation can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the subject innovation, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1120 that can be employed to store information local to the client(s) 1110. Similarly, the server(s) 1130 are operatively connected to one or more server data store(s) 1140 that can be employed to store information local to the servers 1130.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” data storage,” “database,” and substantially any other information storage component relevant to operation and functionality of a component, refer to “memory components,” or entities embodied in a “memory” or components comprising the memory. For example, information relevant to operation of various components described in the disclosed subject matter, and that can be stored in a memory, can comprise, but is not limited to comprising, subscriber information; femtocell configuration (e.g., devices served by a femto AP; access control lists, or white lists) or service policies and specifications; privacy policies; and so forth. It will be appreciated that the memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), phase change memory (PCM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD), Blu-ray disc (BD), . . . ), smart cards, and flash memory devices (e.g., card, stick, key drive . . . ).

What has been described above includes examples of systems and methods that provide advantages of the subject innovation. It is, of course, not possible to describe every conceivable combination of components or methodologies for purposes of describing the claimed subject matter, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system that facilitates efficient processing of orders for access services, comprising:
An address validation engine that determines and validates a geographic location associated with a consumer that requests an access service based at least in part received subset of information associated with the consumer, the validated geographic location is determined to a sub-address level, and the subset of information comprises at least a portion of the geographic location associated with the consumer; and
an access management component that automatically and dynamically determines a cost of the access service and an access provider that provides the access service based at least in part on predefined access criteria.

2. The system of claim 1, the sub-address level relates to at least one of a room number, a floor number, or a building number associated with the validated geographic location.

3. The system of claim 1, the address validation engine presents one or more geographic locations that are potentially associated with the consumer.

4. The system of claim 3, the access management component determines a respective confidence level for at least a portion of at least one of the one or more geographic locations and respectively highlights the at least a portion of the at least one of the one or more geographic locations based at least in part on a respective confidence level associated with the at least a portion of the at least one of the one or more geographic locations to facilitate validating one of the one or more geographic locations.

5. The system of claim 1, further comprising:
a rule engine that contains one or more rules that facilitate determining the cost of the access service and the access provider, wherein the one or more rules are generated in accordance with the predefined access criteria.

6. The system of claim 5, the predefined access criteria relates to at least one of the validated geographic location associated with the consumer, whether a particular access provider can provide the access service to the validated geographic location, respective costs of the access service from respective access providers, whether a particular access provider is able to provide the access service within a specified time frame, whether an access provider meets or exceeds specified performance parameters in relation to providing the access service or other services, or preference of the consumer with regard to an access provider.

7. The system of claim 6, the access management component selects the access provider based at least in part on the access provider being able to provide the access service at lowest cost as compared to other access providers when the access provider also meets other predefined access criteria.

8. The system of claim 6, the rule engine respectively weights each access criterion of the predefined access criteria, and the access management component evaluates each available access provider, generates a respective rating for each available access provider, and selects an available access provider having the highest rating to be the access provider to provide the access service based at least in part on the predefined access criteria.

9. The system of claim 1, the access management component automatically generates an access service request and autopopulates at least one information field in the access service request to facilitate provisioning the access service for the consumer.

10. The system of claim 1, the access management component employs electronic bonding (e-bonding) that comprises a customized interfaces that enables automatic communication of information related to the order between the access management component and the access provider to facilitate at least one of routing of the order, processing of the order, provisioning of the access service, tracking status of the order, or billing the consumer for the access service.

11. The system of claim 1, further comprising:
a central repository that stores and provides information related to processing orders for access services, comprising at least one of an address data store that stores and provides information that facilitates determining and validating the geographic location of the consumer to a sub-address level, a service data store that stores and provides information that facilitates determining availability of an access provider to provide the access service to the consumer at the validated geographic location, or an access provider data store that stores and provides information that facilitates determining cost of the access service and the access provider that will provide the access service.

12. The system of claim 1, the access management component generates a request for access service associated with another consumer and stores the request, the request comprising at least one parameter related to an access service associated with the request.

13. The system of claim 12, the access management component tracks an amount of time that the request for access service is pending, and, when the request is accessed for further processing, the access management component determines the amount of time that the request for access service has been pending and determines that the at least one parameter is no longer valid if more than a predetermined amount of time has elapsed since the request for access service was generated or determines that the at least one parameter remains valid if less than a predetermined amount of time has elapsed since the request for access service was generated.

14. The system of claim 13, the at least one parameter relates to at least one of cost of the access service or availability of an access provider to provide the access service.

15. The system of claim 1, the access management component generates an object that stores information related to the order for access service, the object is one of a token, a file, or a data packet.

16. A method that facilitates processing an order for an access service associated with a consumer, comprising:
validating a geographic location associated with the consumer to a specified level of granularity based at least in part on received information comprising geographical information that at least partially identifies the geographic location; and
automatically and dynamically determining cost of the access service and an access provider that will provide the access service to the consumer at the validated geographic location based at least in part on the validated geographic location and predefined access criteria.

17. The method of claim 16, further comprising:
receiving the information comprising the geographical information that at least partially identifies the geographic location;
retrieving additional information to facilitate validating the geographic location;
presenting one or more geographic locations;
determining respective confidence levels for at least a portion of the one or more geographic locations; and
respectively highlighting the at least a portion of the one or more geographic locations based at least in part on the respective confidence levels to facilitate validating one of the one or more geographic locations.

18. The method of claim 17, further comprising:
indicating that a geographic location is not validated when the geographic location is not accurately determined to the specified level of granularity;
requesting new information, comprising new geographical information that at least partially identifies the geographic location, from the consumer to facilitate validating the geographic location associated with the consumer;
retrieving other information to facilitate validating the geographic location; and
presenting one or more other geographic locations.

19. The method of claim 16, further comprising:
determining type of access service requested by the consumer; and
automatically determining whether at least one access provider of a plurality of access providers is available to provide the access service.

20. The method of claim 19, further comprising:
accessing at least one predefined rule that is generated in accordance with the predefined access criteria;
retrieving access provider information respectively associated with a plurality of access providers; and
evaluating information contained in the order and the access provider information to facilitate automatically and dynamically determining the cost of the access service and the access provider in accordance with the at least one predefined rule.

21. The method of claim 20, the access provider information comprising at least one of cost of the access service, time frame for providing the access service to the consumer, or performance data, respectively associated with each of the plurality of access providers.

22. The method of claim 20, further comprising:
automatically and dynamically selecting the access provider that offers the access service at a lowest cost to provide the access service, while meeting predefined minimum standards related to other predefined access criteria.

23. The method of claim 20, further comprising:
respectively weighting each access criterion of the predefined access criteria;
generating a rating value for each of the plurality of access providers based at least in part on the at least one predefined rule in accordance with the respective weighting of each access criterion; and
automatically and dynamically selecting the access provider that has a highest rating value to provide the access service.

24. The method of claim 16, the predefined access criteria relates to at least one of the validated geographic location associated with the consumer, whether a particular access provider can provide the access service to the validated geographic location, respective costs of the access service from respective access providers, whether a particular access provider is able to provide the access service within a specified time frame, whether an access provider meets or exceeds specified performance parameters in relation to providing the access service or other services, or preference of the consumer with regard to an access provider.

25. The method of claim 16, further comprising:
generating an access service request;
autopopulating at least one field in the access service request with information associated with the order for the access service; and
routing the access service request to the access provider.

26. The method of claim 16, further comprising:
provisioning the access service; and
billing the consumer for the access service.

27. The method of claim 26, further comprising:
utilizing electronic bonding (e-bonding) to facilitate automatically communicating information related to the order between the access provider and an entity processing the order to facilitate at least one of routing of the order for the access service, processing of the order for the access service, provisioning the access service, billing the consumer for access service, or checking the status of the order for the access service.

28. The method of claim 16, further comprising:
generating a request for access service associated with a consumer;
entering at least one parameter in the request for access service;
generating a time stamp indicating the data and time the request for access service was generated;
associating the time stamp with the request for access service; and
storing the request for access service and time stamp.

29. The method of claim 28, further comprising:
monitoring an amount of time that the request for access service has been pending;
accessing the stored request for access service and time stamp;
determining whether the at least one parameter in the request for access service is valid based at least in part on the time stamp and the amount of time that the request for access service has been pending; and
at least one of:
indicating that the at least one parameter is valid if the request for access service has not been pending for more than a predetermined amount of time, and
submitting the request for access service as an order for access service for processing; or
indicating that the at least one parameter is not valid if the request for access service has been pending for more than a predetermined amount of time, and
requesting at least one new parameter value to replace the at least one parameter with a valid parameter value.

30. A computer-readable medium having instructions stored thereon that, when executed by a processor, cause a computer to perform the following acts:
validating a geographic location associated with a consumer to a specified level of granularity based at least in part on received information comprising geographical information that at least partially identifies the geographic location; and
automatically determining cost of an access service and an access provider that will provide the access service to the consumer at the validated geographic location, based at least in part on the validated geographic location and predefined access criteria, to facilitate processing an order for the access service associated with the consumer and provisioning of the access service.

31. An apparatus comprising:
means for validating a geographic location associated with a consumer to a specified level of granularity based at least in part on received information comprising geographical information that at least partially identifies the geographic location;
means for automatically and dynamically determining cost of an access service and selecting an access provider that will provide the access service to the consumer at the validated geographic location, based at least in part on the validated geographic location and predefined access criteria, to facilitate processing an order for the access service associated with the consumer and provisioning of the access service.
